(19) United States
(12) Patent Application Publication
(10) Pub. No.: US 2013/0268247 A1
(43) Pub. Date: Oct. 10, 2013

(54) SYSTEM AND METHOD FOR RESERVOIR PRESSURE DATA ANALYSIS

(71) Applicants: Dana Edward Rowan, Kinwood, TX (US); Shamsul Aziz, Houston, TX (US)

(72) Inventors: Dana Edward Rowan, Kinwood, TX (US); Shamsul Aziz, Houston, TX (US)

(73) Assignee: Chevron U.S.A. Inc., San Ramon, CA (US)

(21) Appl. No.: 13/440,094

(22) Filed: Apr. 5, 2012

(51) Int. Cl. G06F 7/60

(52) U.S. Cl. 703/2

(57) ABSTRACT

A method of modeling pressure characteristics of a reservoir includes obtaining cumulative fluid production data for a plurality of wells in the reservoir for a selected time, obtaining reservoir pressure depletion values for an independent set of wells at the selected time, determining a well spacing value for each of the plurality of production wells, using the cumulative fluid production data and the well spacing values, calculating a cumulative fluid production per unit area value for each of the plurality of wells, calculating a relationship between the reservoir pressure depletion values and the cumulative fluid production per unit area values, using the calculated relationship, generating residual depletion pressure data, and using the calculated relationship and the residual depletion pressure data to transform cumulative fluid production data into predicted pressure values for reservoir flow units.

### BACKGROUND

1. Field

The present invention relates generally to reservoir management and more particularly to analysis of pressure data to assist in reservoir production evolution decisions.

2. Background

Reservoir management in a mature well field can include decisions relating to location of in-fill producing wells, water injection locations, and thermal recovery operations, among others. Typically, in order to understand the pressure distribution within the field a model is developed (e.g., a porosity/permeability fluid model), upscaled to produce a reservoir simulator, and run with data including production, pressure and fluid property data to produce predicted production values. The predicted production values may be compared to historical production data

### SUMMARY

An aspect of an embodiment of the present invention includes a method of modeling pressure characteristics of a reservoir including obtaining cumulative fluid production data for a plurality of wells in the reservoir for a selected time, obtaining reservoir pressure depletion values for an independent set of wells at the selected time, determining a well spacing value for each of the plurality of production wells, using the cumulative fluid production data and the well spacing values, calculating a cumulative fluid production per unit area value for each of the plurality of wells, calculating a relationship between the reservoir pressure depletion values and the cumulative fluid production per unit area values, using the calculated relationship, generating residual depletion pressure data, and using the calculated relationship and the residual depletion pressure data to transform cumulative fluid production data into predicted pressure values for reservoir flow units.

An aspect of an embodiment may include a system for performing any of the foregoing methods.

An aspect of an embodiment of the present invention includes a system including a data storage device and a processor, the processor being configured to perform the foregoing method.

Aspects of embodiments of the present invention include computer readable media encoded with computer executable instructions for performing any of the foregoing methods and/or for controlling any of the foregoing systems.

### DESCRIPTION OF THE DRAWINGS

Other features described herein will be more readily apparent to those skilled in the art when reading the following detailed description in connection with the accompanying drawings, wherein:

FIG. 1 is a map illustrating historical production from wells in a reservoir;

FIG. 2 is a map illustrating local well spacing for each producer in the reservoir;

FIG. 3 is a map illustrating cumulative production per acre;

FIG. 4 is a plot of depletion pressure vs. cumulative fluid production;

FIG. 5 is a plot of depletion pressure vs. cumulative fluid production, coded to illustrate departure from best fit line;

FIG. 6 is a map illustrating departure from the best fit line;

FIG. 7 is a pressure depletion map; and

FIG. 8 is a flowchart illustrating a method in accordance with an embodiment of the invention.

### DETAILED DESCRIPTION

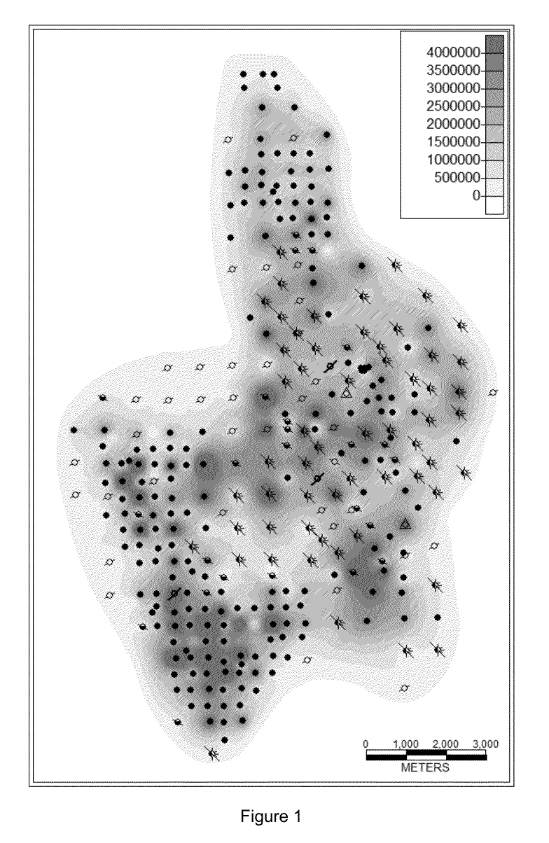

In accordance with an embodiment of the present invention, a method for analyzing pressure data in a mature reservoir involves a workflow in which historical production data is combined with pressure data and well density to model likely pressure fields in the reservoir. To begin, a two-dimensional cumulative fluid production grid (CFPG) is built. This may be, for example, an association between particular wells and their historic production in reservoir barrel units. This historical production data should correspond to a time at which the reservoir pressure is measured, for example using an MDT tool for formation pressure measurement. The CFPG may be constrained by assuming a productive area that honors a reservoir bounding contour of zero value at the interpreted position of zero drainage. FIG. 1 is an example of a map illustrating the historical total fluid production over the reservoir area.

As will be appreciated, FIG. 1 provides a good indication as to which regions of the reservoir have historically high/low total fluid withdrawal levels. However, it should also be appreciated that for more densely drilled regions, the Figure tends to overemphasize the productivity of any individual well. Therefore, in order to better correlate production to pressure, the map may be normalized to account for well spacing to create a “Cumulative Total Fluid per Acre” grid.

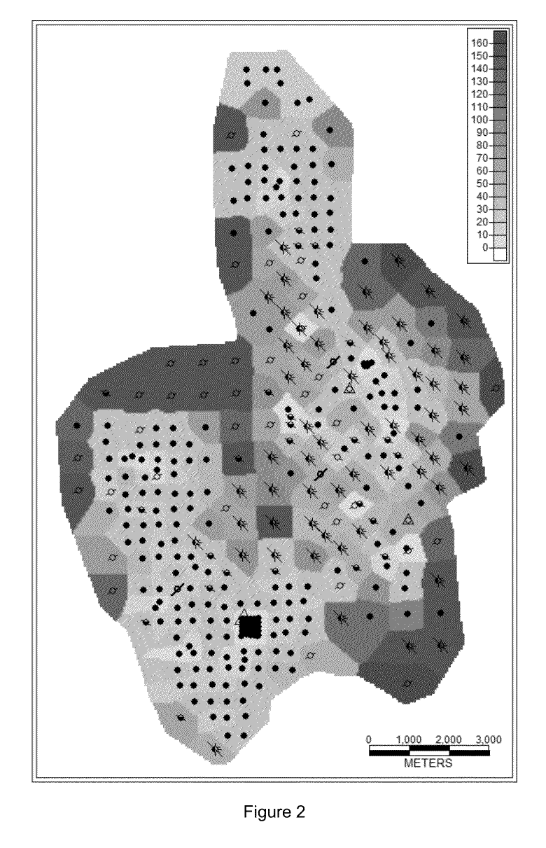

In this approach, a well spacing value (WSV) is calculated for each well, based on the distance to the nearest producing neighbor at the time of MDT acquisition. Thus, using measured distances (for example, calculated differences in GPS coordinates, survey results or other measurements) and the calculated relationship, the WSV can be calculated. An example is illustrated in FIG. 2.

In the illustrated example, a minimum inter-well distance (m) for every producer in the group of wells under study was computed. Finally a closest-point algorithm was used to grid the resulting values. As will be appreciated, a variety of alternate algorithms could be used to determine the gridding.

In general, wells on the perimeter of the field have higher apparent well spacing values than interior wells, because they have no nearest neighbor in the edgewise direction. Portions of the field in which there are several wells, on the other hand, result in lower calculated spacing values. In the case of perimeter wells, it is possible to limit the edge effects by constraining the well spacing calculation by, for example, assigning an edgewise nearest neighbor spacing value equal to an average well spacing for the actual nearest neighbors.

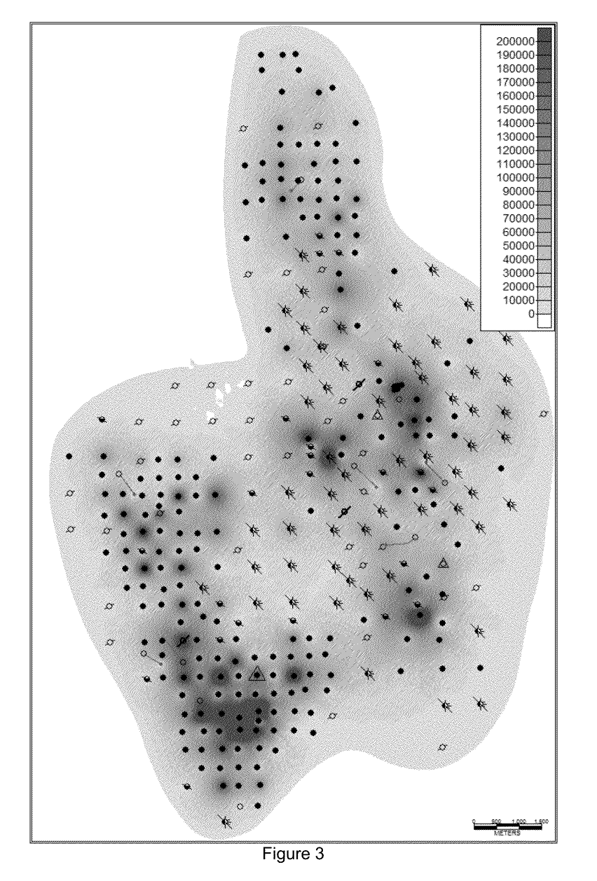

Once the CFPG and the WSV are determined, a cumulative total fluid produced per acre (CTFPPA) metric may be calculated by dividing the CFPG sampled metric by the WSV for all of the producing wells that are to be used in the analysis. This CTFPPA is then used to generate a two-dimensional grid. A grid of this type is illustrated in FIG. 3. As described above, a constraint is applied such that the reservoir limit is defined to be a zero contour. This map may be interpreted as illustrating predicted trends in the measured MDT pressure data. Once built, the grid may be sampled, for example by well, to capture values for a grid-based cumulative total fluid per acre.

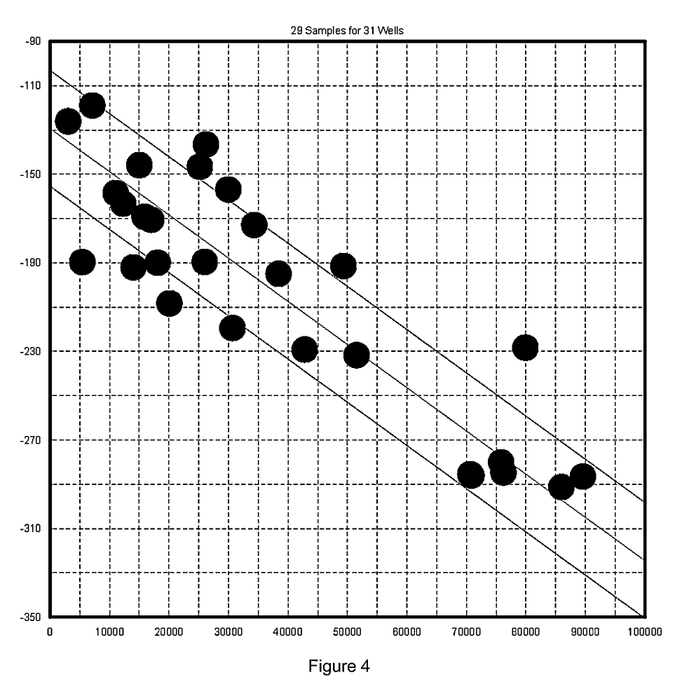

For each measured MDT pressure at the selected layer (in this case, the selected layer is a few tens of feet above a perceived discontinuity identified by examination of well logs), an average depletion pressure was calculated. That is, a change in MDT measured formation pressure from the original reservoir pressure gradient was determined for each MDT acquisition pressure. The depletion pressure was then cross plotted against the calculated CTFPPA as illustrated in FIG. 4.

A best fit equation for the MDT depletion pressure and CTFPPA relationship was developed. In this example, Y=−0.001950X−128.7. As long as there is an acceptable correlation factor, the data may be considered to be suited to analysis in accordance with the present method. Where correlation is low (e.g., less than a magnitude of 0.5), the inventive method may not find particular applicability. At the least, it should be appreciated that a high degree of uncertainty will result in the calculations. Thus, in systems in which provenance information is recorded and transmitted through a workflow, output from this sub-workflow may be tagged as having high uncertainty.

As will be appreciated, the example illustrated in FIG. 4 shows good correlation (correlation factor: −88%) between depletion pressure and fluid production. This indicates that for these sampled wells, the change in pressure can probably be attributed to the removal of fluid by production, and is less likely to be the result of some undetermined geological process.

A residual depletion pressure may be calculated by subtracting the measured and calculated (MDT) depletion pressure from the best fit relationship developed above. This residual depletion pressure may then be used to generate a two dimensional grid.

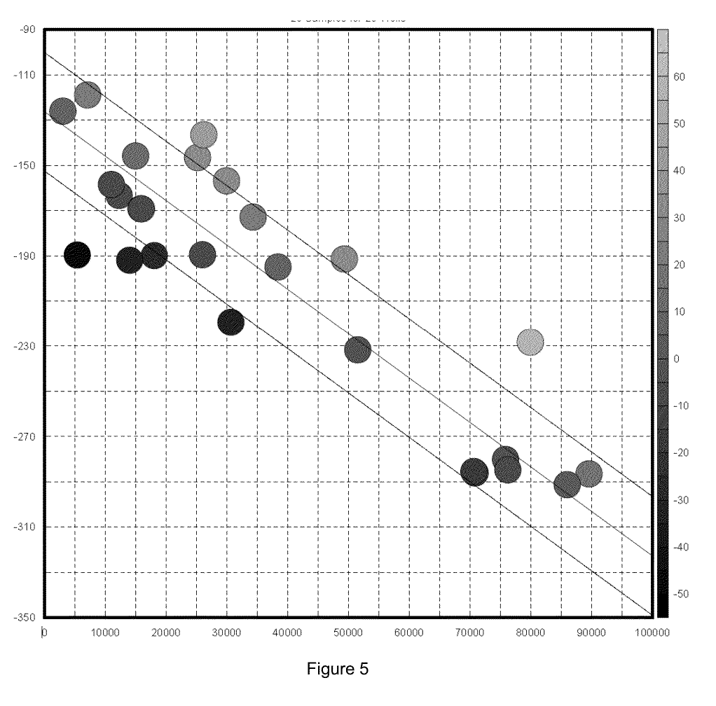

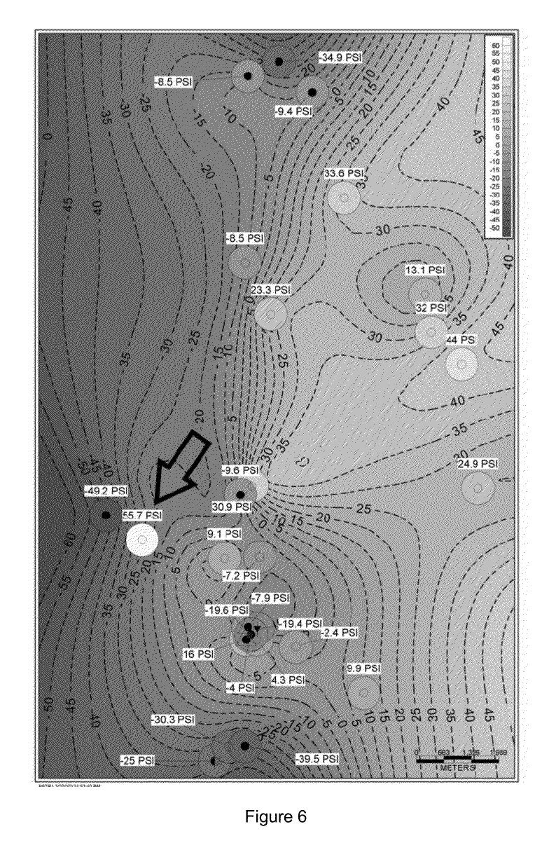

FIG. 6 is a map generated from the pressure departure information. That is, the map is generated showing how various regions of the reservoir behave compared to the trend, with grey scale values as shown in FIG. 5. Put another way, the cumulative total fluid produced per acre is operated on based on the best fit equation to calculate a grid of depletion pressures for all areas which may be referred to as a predicted pressure depletion grid (PPDG).

The bubbles in the PPDG represent particular wells and are colored in accordance with a scale. In the example, the well indicated by the arrow is not used in the gridding because in this case, there is a nearby early life prolific well which results in a biased value for the cumulative total fluid/acre measurement. In general, a user may designate particular wells to be excluded from the data set based on geophysical properties or other information that the user interprets as indicating an unreliable statistic. Alternately, outliers may be automatically excluded based on predetermined criteria.

As may be seen from the map of FIG. 6, the left (western) side of the reservoir tends to have a lower pressure deviation from average (i.e., negative deviation, below the trend line) while the right (Eastern) side of the reservoir tends to have a higher pressure deviation than average (i.e., positive deviation, above the trend line). The center, approximately along a North-South line, is generally close to the trend line.

The pressure trend information illustrated in FIG. 6 is then inspected to locate possible regions that are experiencing pressure recharge. That is, for regions indicating a higher than trend deviation, it may be that there is a geological reason for the unexpected pressure values. In the present case, extraneous water was known to be present in the eastern, central portion of this field (in this case, a dump flood region). Overall, the entire eastern portion of the field appears to be experiencing recharge. As will be appreciated, this means that when making decisions on placement of steam injection wells for secondary production, the eastern portion of the reservoir is less likely to be effective as the recharging water will tend to absorb heat energy from the steam.

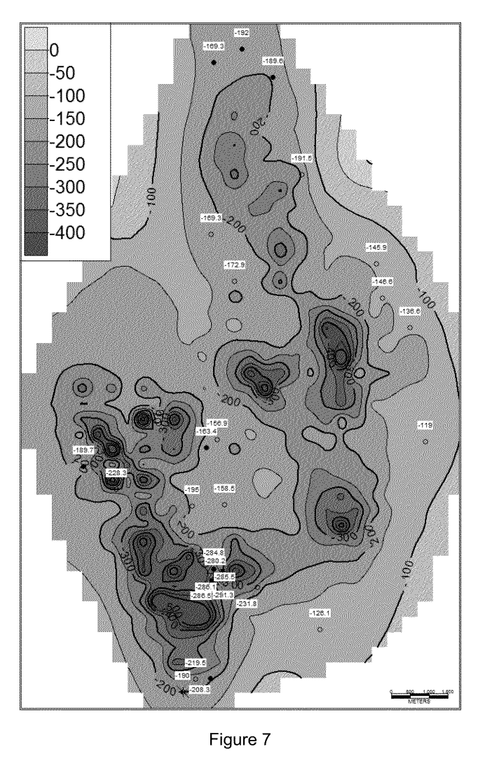

The PPDG is then summed with the residual depletion grid to construct a residual corrected predicted pressure depletion grid (RCPPDG), as illustrated in FIG. 7. This final 2D grid will honor both the relationship established between production and observed MDT recorded pressures as well as field trends in depletion pressures.

In the example of FIG. 7, the Pressure Depletion Grid was calculated based on the formula: ((−0.00195×(Cumulative Prod Total Fluid per acre Grid))−130)+(Pressure Departure Grid).

In an embodiment, a user may use the resulting pressure depletion grid as a coarse model of the fluid flows within the reservoir. In contrast to a standard reservoir model based on porosity and permeability and modeling flows through a three dimensional grid representing the reservoir, the calculations required are relatively simple, and computational burden is low. Nonetheless, quantitative information may be gleaned relating to, for example, recharge, connectivity and other hydrodynamic characterizations of the reservoir. The resulting understanding may be used, for example, in placing steam injection wells, additional production (infill) wells, waterflood operations, or other reservoir management decisions. In an embodiment, results may be used as a cross check for more detailed simulations, or vice versa.

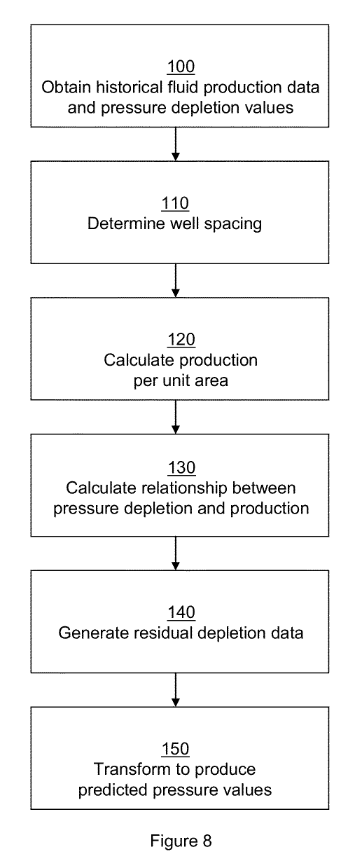

FIG. 8 is a flowchart illustrating a workflow for the foregoing method. Data, including computer-readable cumulative fluid production for a plurality of production wells in a reservoir over a selected time period and pressure depletion values for each of the production wells is obtained, 100. As will be appreciated, depletion pressure may be obtained by operation of an MDT or other pressure transducer. Historical fluid production for a well may be monitored continuously, or estimated over time, and is commonly monitored in reservoir management workflows.

A well spacing is determined (110) for each of the production wells and provided as computer-readable data. The computer system uses the well spacing data in combination with the fluid production data and calculates (120) values of cumulative fluid production per unit area for each region of the reservoir.

A relationship between reservoir pressure depletion and cumulative fluid production per unit area is calculated (130). Using the calculated relationship between the pressure depletion and the cumulative fluid production per unit area, residual depletion pressure data is generated (140) using the computer. Finally, the calculated relationship and the residual depletion pressure data are used to transform (150) cumulative fluid production data into predicted pressure values for reservoir flow units using the computer. As will be appreciated, the predicted pressure values may be coded and displayed to produce a reservoir map that may allow a subject-matter expert to make qualitative determinations regarding the subsurface structure.

As will be appreciated, the method as described herein may be performed using a computing system having machine executable instructions stored on a tangible medium. The instructions are executable to perform each portion of the method, either autonomously, or with the assistance of input from an operator. In an embodiment, the system includes structures for allowing input and output of data, and a display that is configured and arranged to display the intermediate and/or final products of the process steps. A method in accordance with an embodiment may include an automated selection of a location for exploitation and/or exploratory drilling for hydrocarbon resources. Where the term processor is used, it should be understood to be applicable to multi-processor systems and/or distributed computing systems.

Those skilled in the art will appreciate that the disclosed embodiments described herein are by way of example only, and that numerous variations will exist. The invention is limited only by the claims, which encompass the embodiments described herein as well as variants apparent to those skilled in the art. In addition, it should be appreciated that structural features or method steps shown or described in any one embodiment herein can be used in other embodiments as well.

I/we claim:

1. A method of modeling pressure characteristics of a reservoir, comprising:
obtaining computer-readable cumulative fluid production data for a plurality of production wells in the reservoir for a selected time;
obtaining computer-readable reservoir pressure depletion values for an independent set of wells at the selected time;
determining, using a computer, a well spacing value for each of the plurality of production wells;
using the cumulative fluid production data and the well spacing values, calculating, using the computer, a cumulative fluid production per unit area value for each of the plurality of wells;
calculating, using the computer, a relationship between the reservoir pressure depletion values and the cumulative fluid production per unit area values;
using the calculated relationship, generating residual depletion pressure data using the computer; and
using the calculated relationship and the residual depletion pressure data to transform cumulative fluid production data into predicted pressure values for reservoir flow units using the computer.

2. A method as in claim 1, further comprising, using the predicted pressure values to determine a site for drilling an injection well.

3. A method as in claim 1, further comprising, using the predicted pressure values to determine a site for drilling a production well.

4. A method as in claim 1, wherein the obtaining reservoir pressure depletion values comprises taking pressure measurements at selected depths using a modular formation dynamics testing tool.

5. A method as in claim 1 wherein the generating residual depletion pressure data comprises comparing, using the computer, measured pressure depletion values to a trend line representing the calculated relationship.

6. A method as in claim 1, further comprising, generating, using the computer, a map of the reservoir from the predicted pressure values, the map providing a visualization of the reservoir structure.

7. A method as in claim 1, wherein, for the calculated relationship, a correlation factor is calculated using the computer, and wherein for correlation factors having magnitude of 0.5 or less, a high degree of uncertainty is assigned to the predicted pressure values.

8. A tangible computer readable medium encoded with computer executable instructions for performing a method of modeling pressure characteristics of a reservoir using computer-readable computer-readable cumulative fluid production data for a plurality of production wells in the reservoir for a selected time and computer-readable reservoir pressure depletion values for an independent set of wells at the selected time, comprising:
determining, using a computer, a well spacing value for each of the plurality of production wells;
using the cumulative fluid production data and the well spacing values, calculating, using the computer, a cumulative fluid production per unit area value for each of the plurality of wells;
calculating, using the computer, a relationship between the reservoir pressure depletion values and the cumulative fluid production per unit area values;
using the calculated relationship, generating residual depletion pressure data using the computer; and
using the calculated relationship and the residual depletion pressure data to transform cumulative fluid production data into predicted pressure values for reservoir flow units using the computer.
